(19) United States
(12) Patent Application Publication
(10) Pub. No.: US 2017/0054620 A1
(43) Pub. Date: Feb. 23, 2017

(54) METHOD FOR DETECTING SHARING TERMINAL USING BROWSER TYPE, AND APPARATUS THEREFOR

(71) Applicant: SOOSAN INT CO., LTD., Seoul (KR)

(72) Inventor: Kyoung Pil KONG, Seoul (KR)

(21) Appl. No.: 15/307,550

(22) PCT Filed: Apr. 15, 2015
(86) PCT No.: PCT/KR2015/003744

§ 371 Date: Oct. 28, 2016

(30) Foreign Application Priority Data
Apr. 30, 2014 (KR) 10-2014-0052950

(51) Int. Cl. H04L 12/26; H04L 29/12; H04L 29/08

(52) U.S. Cl. CPC H04L 43/0876; H04L 67/02; H04L 61/2007; H04L 67/146

(57) ABSTRACT

A method and apparatus for detecting a sharing terminal by using a browser type are provided. In response to an Internet connection traffic of a terminal, the apparatus analyzes the Internet connection traffic to ascertain a type of an Internet connection browser and cookie information that is provided to the terminal by a server to which the terminal attempts to connect. Then, the apparatus detects whether the terminal is a sharing terminal, based on the number of different pieces of cookie information for each type of Internet connection browser checked for a predetermined period.

### TECHNICAL FIELD

The present invention relates to a method and apparatus for detecting terminals that share a single public Internet address, and more particularly, to a method and apparatus for detecting sharing terminals by using the type of a browser used by a terminal for Internet connection.

### BACKGROUND ART

On the Internet, terminals are assigned respective unique Internet Protocol (IP) addresses and communicate with one another by using their IP addresses. However, when several terminals share a single public IP address by using an Internet sharer, it is impossible to identify each of the terminals that use the single public IP address.

In a conventional method for addressing this problem, a program for acquiring a private IP of each terminal within a private network is inserted into each terminal, or unique information used to identify each terminal is inserted into the terminal by using a cookie or a flash-shared object.

However, to acquire a private IP, a special program should be installed in a terminal. When each user does not install the program, terminal identification is impossible. To insert the unique information into a cookie of the terminal, an Internet connection traffic of the terminal should be intercepted and redirected to a third server.

### DETAILED DESCRIPTION OF THE INVENTION

### Technical Problem

The present invention provides a method and apparatus for detecting terminals that share a public Internet address, based on the type of a browser that is used by a terminal to achieve Internet connection, without needing to insert unique information used for terminal identification into each terminal or to redirect an Internet connection traffic of the terminal to a third server.

### Technical Solution

According to an aspect of the present invention, there is provided a sharing terminal detecting method including receiving an Internet connection traffic of a terminal; analyzing the Internet connection traffic to ascertain a type of an Internet connection browser and cookie information provided to the terminal by a server to which the terminal attempts to connect; and detecting whether the terminal is a sharing terminal, based on the number of different pieces of cookie information for each type of Internet connection browser checked for a predetermined period.

According to another aspect of the present invention, there is provided a sharing terminal detecting apparatus including a receiver configured to receive an Internet connection traffic; a packet analyzer configured to analyze the Internet connection traffic to ascertain a type of an Internet connection browser and identification (ID) information that a server to which the terminal attempts to connects stores in a local storage of the terminal; a storage configured to store the type of the Internet connection browser and the ID information ascertained by the packet analyzer for each source address of the Internet connection traffic; and a detector configured to detect whether the terminal is a sharing terminal, based on the number of different pieces of ID information for each type of Internet connection browser checked for a predetermined period.

### Advantageous Effects

According to the present invention, a sharing terminal detecting apparatus does not need to insert special unique information used for terminal identification into a cookie of a terminal. Since an Internet connection traffic of a terminal does not need to be redirected, Internet connection of the terminal is not affected.

### DESCRIPTION OF THE DRAWINGS

FIG. 1 illustrates a schematic structure of a system for detecting sharing terminals by using a browser type, according to the present invention.

FIG. 2 illustrates a structure of the sharing terminal detecting apparatus using a browser type, according to an embodiment.

FIG. 3 illustrates a flow of a sharing terminal detecting method using a browser type, according to an embodiment of the present invention.

FIG. 4 is a block diagram of an Internet connection traffic according to an embodiment of the present invention.

FIG. 5 illustrates a result of sharing terminal detection using a browser type, according to an embodiment of the present invention.

### MODE OF THE INVENTION

A method and apparatus for detecting sharing terminals by using a browser type, according to the present invention, will now be described in detail with reference to the accompanying drawings.

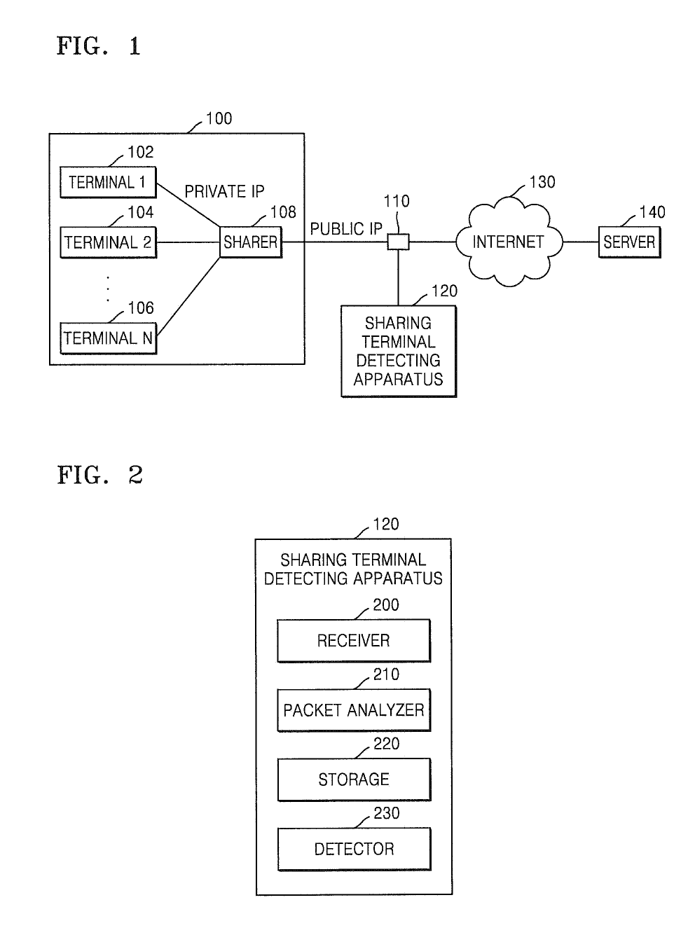

FIG. 1 illustrates a schematic structure of a system for detecting sharing terminals by using a browser type, according to the present invention.

Referring to FIG. 1, a plurality of terminals 102, 104, and 106 share a public Internet address (public Internet protocol (IP) address) by using a sharer 108. The plurality of terminals 102, 104, and 106 use their private Internet addresses (private IP addresses) within a private network 100, and use the public Internet address when they connect to an external server 140 via Internet 130. Accordingly, in the outside of the private network 100, it is impossible to ascertain existence or non-existence of a plurality of terminals by using only the public Internet address.

The terminals 102, 104, and 106 denote all kinds of devices that may be connected to the Internet via a wired and wireless communication network. For example, the terminals 102, 104, and 106 may be computers, tablet PCs, smartphones, or objects of a home network or a things network.

The terminals 102, 104, and 106 connect to the Internet 130 by using an Internet connection browser. For example, the terminals 102, 104, and 106 connect to the Internet by using one of various types of browsers, such as Internet Explorer (IE), Chrome, Safari, and FireFox. A plurality of different types of browsers may exist within the terminals 102, 104, and 106, but different versions of browsers of the same type may not simultaneously exist. In other words, a version 8.0 of Internet Explorer and a version 9.0 of Internet Explorer may not simultaneously exist within a terminal.

The server 140 is a device that provides various services or various pieces of information to the terminals 102, 104, and 106 via the Internet, and thus has a host name and an Internet address. The host name is a combination of characters and numbers that represent the server. For example, the host name may be www.google.com. According to the present embodiment, the host name is defined as including both a case including “www” and a case not including “www”. The server 140 may have a plurality of host names and a plurality of Internet addresses.

When the terminals 102, 104, and 106 connect to the server 140 via a specific browser and pre-assigned identification (ID) information does not exist in the terminals 102, 104, and 106, the server 140 stores the ID information in local storages of the terminals 102, 104, and 106 that may be accessed by the browser. For example, when the server 140 is an online shopping mall, the server 140 may store information of products browsed by the terminals 102, 104, and 106 together with ID information, in local storages of the terminals 102, 104, and 106. Examples of the local storages include cookies and flash shared objects. In particular, the server 140 assigns different pieces of ID information according to different types of browsers via which the terminals 102, 104, and 106 connect to the Internet, and provides the different pieces of ID information to the terminals 102, 104, and 106.

A sharing terminal detecting apparatus 120 detects sharing terminals by using a browser type. A mirroring apparatus 110 is positioned between the private network 100 and the Internet 130 and transmits a traffic transmitted or received between the private network 100 and the Internet 130 to the sharing terminal detecting apparatus 120.

Although the sharing terminal detecting apparatus 120 and the server 140 are illustrated as separate components in FIG. 1 for convenience of explanation, the sharing terminal detecting apparatus 120 may be included in the server 140. In addition, an implementation location of the sharing terminal detecting apparatus 120 may vary according to embodiments, such as implementation of the sharing terminal detecting apparatus 120 at the location of the mirroring apparatus 110.

FIG. 2 illustrates a structure of the sharing terminal detecting apparatus 120 using a browser type, according to an embodiment.

Referring to FIG. 2, the sharing terminal detecting apparatus 120 includes a receiver 200, a packet analyzer 210, a storage 220, and a detector 230.

The receiver 200 receives a traffic that is transmitted from a terminal within a private network to a server. In the embodiment of FIG. 1, the receiver 200 receives a traffic mirrored by the mirroring apparatus 110.

The packet analyzer 210 analyzes the received traffic to ascertain the type of a browser used by the terminal for Internet connection and ID information provided to the terminal by the server to which the terminal attempts to connect. For example, the packet analyzer 210 analyzes a Hypertext Transfer Protocol (HTTP) packet received by the receiver 200, and ascertains a browser type and ID information stored in terminal environment information within the HTTP packet. An example of the HTTP packet is shown in Table 1.

Although the packet analyzer 210 is able to analyze all traffics, the packet analyzer 210 may analyze only a preset analysis-target traffic in order to reduce a load within the sharing terminal detecting apparatus 120. For example, the packet analyzer 210 pre-stores at least one host name, and, when the host name of a destination server for a traffic, namely, the host name of the server to which the terminal attempts to connect, does not exist in the at least one pre-set host name, the packet analyzer 210 discards the corresponding traffic and performs no more processes.

For example, after the packet analyzer 210 previously stores the host name of “Naver (www.naver.com)”, when an Internet connection traffic of a terminal is a connection traffic for “Naver”, the packet analyzer 210 performs sharing terminal detection, and, otherwise, the packet analyzer 210 discards the traffic and performs no more processes.

The storage 220 stores and manages the browser type and the ID information ascertained by the packet analyzer 210, together with the source address of the traffic. The source address denotes a public Internet address of the terminal that transmitted the traffic. Accordingly, in the case of FIG. 1, when the packet analyzer 210 analyzes traffics of the plurality of terminals 102, 104, and 106 and ascertains the source addresses of the traffics, all of the source addresses are the same as one another, that is, a public Internet address.

The detector 230 detects whether the terminal is a sharing terminal, based on the number of different pieces of ID information for each type of a browser ascertained for a certain period. For example, regarding a specific public Internet address, when types of browsers ascertained by the packet analyzer 230 are Internet Explorer and Chrome, two different pieces of ID information exist for the Internet Explorer, and one piece of ID information exists for the Chrome, the detector 230 determines that the number of sharing terminals is 2.

Considering that a user is able to arbitrarily delete a cookie, the detector 230 may repeat the determination as to whether the terminal is a sharing terminal, at short-time intervals. For example, the detector 230 performs detection for one hour, and, after one hour has lapsed, the detector 230 resets stored data and performs detection again.

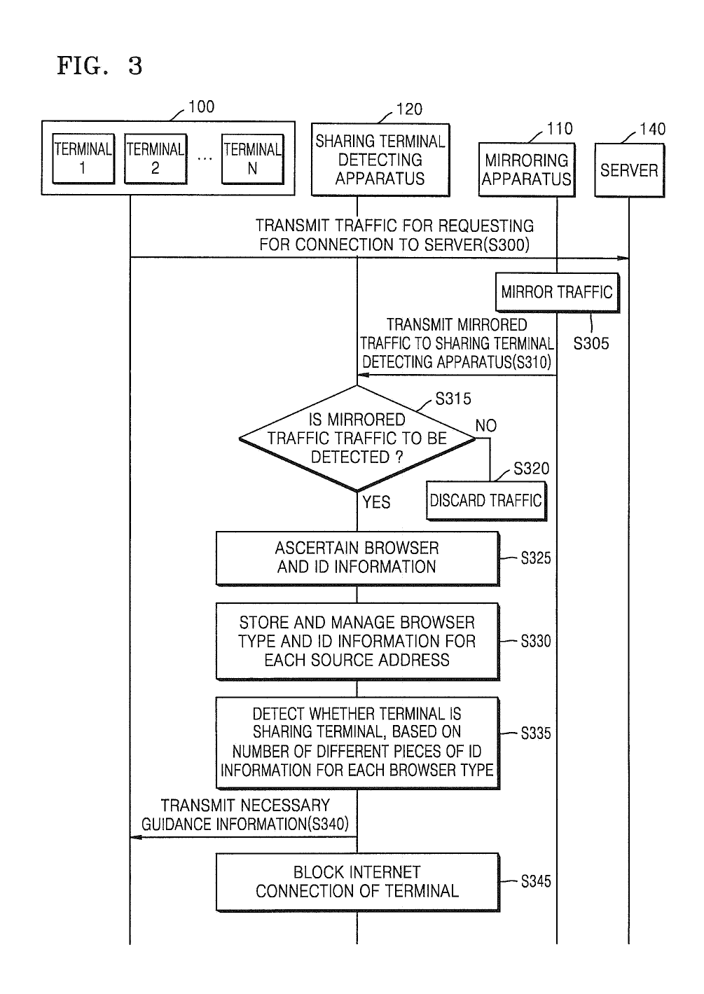

FIG. 3 illustrates a flow of a sharing terminal detecting method using a browser type, according to an embodiment of the present invention.

Referring to FIG. 3, when a terminal within the private network 100 that shares the public Internet address transmit a traffic for requesting for connection to the server 140 in operation S300, the mirroring apparatus 110 mirrors the traffic and transmits the mirrored traffic to the sharing terminal detecting apparatus 120, in operations S305 and S310.

The sharing terminal detecting apparatus 120 ascertains whether the mirrored traffic is a target traffic for detection, in operation S315. For example, the sharing terminal detecting apparatus 120 previously stores the host names of top five portal sites to which users frequently connect, and, when the host name of the server to which the terminal attempts to connect is one of the pre-stored host names of the top five portal sites, the sharing terminal detecting apparatus 120 performs a subsequent detecting operation. Otherwise, the sharing terminal detecting apparatus 120 discards the traffic and performs no more operations, in operation S320.

When it is determined in operation S315 that the mirrored traffic is the target traffic for detection, the sharing terminal detecting apparatus 120 analyzes the traffic to ascertain the type of a browser used by the terminal for Internet connection and ID information pre-stored in the terminal by the server to which the terminal attempts to connect, in operation S325.

In operation S330, the sharing terminal detecting apparatus 120 stores and manages the ascertained browser type and the ascertained ID information, based on the source address of the traffic (i.e., the same public Internet address when the terminal is a sharing terminal). In operation S335, the sharing terminal detecting apparatus 120 ascertains the number of different pieces of ID information for each browser type by using the browser type and the ID information stored for the same public Internet address, and detects whether the terminal is a sharing terminal.

When the terminal is detected as a sharing terminal, the sharing terminal detecting apparatus 120 transmits necessary guidance information, such as informing the terminal of sharing, in operation S340, or the sharing terminal detecting apparatus 120 may block Internet connection of the terminal, in operation S345.

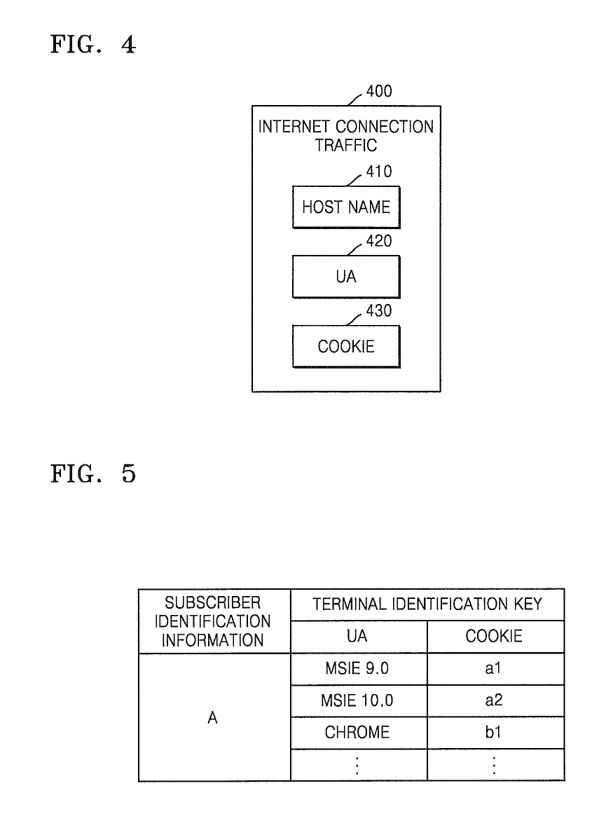

FIG. 4 is a block diagram of an Internet connection traffic 400 according to an embodiment of the present invention.

Referring to FIG. 4, the Internet connection traffic 400 includes a host name 410, a user agent (UA) 420, and a cookie 430. The host name 410 indicates the host name of a destination server of a traffic, the UA 420 indicates environment information of a terminal, such as the type and version information of a browser used for Internet connection, and the cookie 430 indicates ID information that the destination server previously stores in a terminal.

For example, an example of an Internet connection traffic that is transmitted when a terminal connects to a portal site of “Naver (www.naver.com)” by using Chrome is as Table 1.

TABLE 1
Hypertext Transfer Protocol Get / Http/1.1\r\n Host: www.naver.com\r\n
Connection: Keep-alive\r\n Cache-control: max-age=0\r\n Accept:
Text/html.application/xtml+xml.application/xml;q=0.9.image/webp,*/*=0.8\r\n
User-Agent: Mozilla/5.0 (Windows NT 6.3; WOW64) Applewebkit/537.36 (KHTML,
like Gecko) Chrome/34.0.1847.116 Safari/537.36\r\n Accept-Encoding:
gzip,deflate,sdch\r\n Accept-Language:
ko-kr,ko;q=0.8.en-us;q=0.6,en;q=0.4\r\n Cookie: NNB=2FZDCFOTEBHFG;
page_uid=k6wkkwpyLP1ssc7z4k8ssssssgG-139343; nrefreshx=0\r\n

Referring to Table 1, “User-Agent” represents that a terminal has used a browser of Chrome to connect to the Internet, and ID information “NNB=2FZDCFOTEBHFG” received by the terminal connected to “Naver” is stored in “Cookie”.

FIG. 5 illustrates a result of sharing terminal detection using a browser type, according to an embodiment of the present invention.

Referring to FIG. 5, a sharing terminal detecting apparatus detects two browser types of Internet Explorer and Chrome when subscriber ID information is “A”, and two different pieces of cookie information exist for the Internet Explorer. In this case, the sharing terminal detecting apparatus determines that the minimum number of sharing terminals is 2.

For example, a detection process when 7 terminals share a public Internet address and a browser as in Table 2 is installed in each of the terminals will now be described.

TABLE 2

| | Browser |
|---|---|
| Terminal 1 | IE8, Chrome |
| Terminal 2 | IE8, Chrome, Safari |
| Terminal 3 | IE10, Chrome, FireFox |
| Terminal 4 | IE11, Chrome |

An Internet connection situation for each time zone when the detection process is performed at intervals of one hour is as follows.

TABLE 3

| Internet connection situation | result of detection by sharing |
|---|---|
| for each time zone | terminal detecting apparatus |
| Between 1 pm and 2 pm, | Browser type = IE8, Cookie value = a |
| Terminal 1: connection via | Browser type = IE9, Cookie value = b |
| IE8, Terminal 2: connections | Browser type = Opera, Cookie value = c |
| via IE9 and Opera | |
| Between 2 pm and 3 pm, | Browser type = IE9, Cookie value = d |
| Terminal 2: connections via | Browser type = Safari, Cookie value = c |
| IE9 and Safari, Terminal 3: | Browser type = IE10, Cookie value = f |
| connections via IE10 and | Browser type = Chrome, Cookie value = g |
| Chrome, Terminal 4: | Browser type = IE11, Cookie value = h |
| connections via IE11 and | Browser type = Chrome, Cookie value = i |
| Chrome | |
| Between 3 pm and 4 pm, | Browser type = IE8, Cookie value = a |
| Terminal 1: connection via | Browser type = FireFox, Cookie value = j |
| IE8, Terminal 3: connection | |
| via FireFox | |

The minimum number of sharing terminals for each time zone when an Internet connection situation as in Table 3 occurs is ascertained as in Table 4.

TABLE 4

| | Minimum number of sharing terminals |
|---|---|
| Between 1 pm and 2 pm | Two sharing terminals use IE and one |
| | sharing terminal uses Opera. |
| Between 2 pm and 3 pm | Four sharing terminals use IE, one sharing |
| | terminal uses Safari, and two sharing |
| | terminals use Chrome. |
| Between 3 pm and 4 pm | Two sharing terminals use IE and one |
| | sharing terminal uses FireFox. |

Accordingly, the sharing terminal detecting apparatus ascertains that the minimum number of sharing terminals between 1 pm and 2 pm is 2 and that the number of sharing terminals between 2 pm and 3 pm is 4.

The present invention can be embodied as computer readable codes on a computer readable recording medium. The computer readable recording medium is any type of recording device that stores data which can thereafter be read by a computer system. Examples of the computer-readable recording medium include ROM, RAM, CD-ROMs, magnetic tapes, floppy discs, and optical data storage media. The computer readable recording medium can also be distributed over network coupled computer systems so that the computer readable code is stored and executed in a distributive manner.

While the present invention has been particularly shown and described with reference to exemplary embodiments thereof, it will be understood by those of ordinary skill in the art that various changes in form and details may be made therein without departing from the spirit and scope of the invention as defined by the appended claims. It should be understood that the exemplary embodiments should be considered in a descriptive sense only and not for purposes of limitation. Therefore, the scope of the inventive concept is defined not by the detailed description of the inventive concept but by the appended claims, and all differences within the scope will be construed as being included in the inventive concept.

1. A sharing terminal detecting method comprising:
receiving an Internet connection traffic of a terminal;
analyzing the Internet connection traffic to ascertain a type of an Internet connection browser and cookie information provided to the terminal by a server to which the terminal attempts to connect; and
detecting whether the terminal is a sharing terminal, based on the number of different pieces of cookie information for each type of Internet connection browser checked for a predetermined period.

2. The sharing terminal detecting method of claim 1, wherein the receiving comprises mirroring and receiving the Internet connection traffic that is transmitted to the server.

3. The sharing terminal detecting method of claim 1, wherein the receiving comprises:
comparing a host name of a destination server of the Internet connection traffic with a pre-stored host name; and
discarding the Internet connection traffic when the host name of the destination server is different from the pre-stored host name.

4. The sharing terminal detecting method of claim 1, wherein the receiving comprises receiving an Internet connection traffic from a terminal that attempts to connect to the Internet by using one of a plurality of different types of Internet connection browsers.

5. The sharing terminal detecting method of claim 1, wherein the terminal is a terminal that shares a public Internet address.

6. The sharing terminal detecting method of claim 1, wherein
the Internet connection traffic is a Hypertext Transfer Protocol (HTTP) packet, and
the ascertaining comprises ascertaining a type of the Internet connection browser by using a user agent included in the HTTP packet.

7. The sharing terminal detecting method of claim 1, wherein the detecting of whether the terminal is a sharing terminal comprises:
ascertaining an source address of the Internet connection traffic; and
detecting whether the terminal is a sharing terminal, based on the number of different pieces of cookie information for each Internet connection browser with respect to the source address.

8. A sharing terminal detecting apparatus comprising:
a receiver configured to receive an Internet connection traffic;
a packet analyzer configured to analyze the Internet connection traffic to ascertain a type of an Internet connection browser and identification (ID) information that a server to which the terminal attempts to connects stores in a local storage of the terminal;
a storage configured to store the type of the Internet connection browser and the ID information ascertained by the packet analyzer for each source address of the Internet connection traffic; and
a detector configured to detect whether the terminal is a sharing terminal, based on the number of different pieces of ID information for each type of Internet connection browser checked for a predetermined period.

9. The sharing terminal detecting apparatus of claim 8, further comprising a mirroring apparatus configured to mirror the Internet connection traffic that a terminal that shares a public Internet address transmits to the destination server,
wherein the receiver receives an Internet connection traffic mirrored by the mirroring apparatus.

10. The sharing terminal detecting apparatus of claim 8, wherein, when a host name of the destination server of the Internet connection traffic does not exist within a pre-stored host name, the packet analyzer discards the Internet connection traffic.

11. The sharing terminal detecting apparatus of claim 8, wherein the receiver receives an Internet connection traffic from a terminal that attempts to connect to the Internet by using one of a plurality of different types of Internet connection browsers.

12. The sharing terminal detecting apparatus of claim 8, wherein the terminal is a terminal that shares a public Internet address.

13. The sharing terminal detecting apparatus of claim 8, wherein
the Internet connection traffic is a Hypertext Transfer Protocol (HTTP) packet, and
the packet analyzer is configured to ascertain a type of the Internet connection browser by using a user agent included in the HTTP packet.

14. The sharing terminal detecting apparatus of claim 8, wherein the detector is configured to detect the number of sharing terminals by calculating the number of different pieces of cookie information for each type of Internet connection browser with respect to the each source address of the Internet connection traffic.

15. A non-transitory computer-readable recording medium having recorded thereon a computer program, which, when executed by a computer, performs the method of claim 1.

16. The sharing terminal detecting method of claim 2, wherein the receiving comprises:
comparing a host name of a destination server of the Internet connection traffic with a pre-stored host name; and
discarding the Internet connection traffic when the host name of the destination server is different from the pre-stored host name.
